(19) United States
(12) Patent Application Publication
(10) Pub. No.: US 2026/0165899 A1
(43) Pub. Date: Jun. 18, 2026

(54) Multiple Position-Reconfigurable Haptic Handle for the Whole Hand

(71) Applicant: Recupero Robotics LLC, Philadelphia, PA (US)

(72) Inventors: Michelle Johnson, Wilmington, DE (US); Alwyn Johnson, Hudson, CO (US); Samuel Gaardsmoe, Philadephia, PA (US)

(21) Appl. No.: 19/422,417

(22) Filed: Dec. 16, 2025

Related U.S. Application Data
(60) Provisional application No. 63/734,688, filed on Dec. 16, 2024.

(51) Int. Cl. A61H 1/02; A63B 21/00; A63B 21/005; A63B 23/16

(52) U.S. Cl. CPC A61H 1/0288; A63B 21/00178; A63B 21/0058; A63B 21/4035; A63B 21/4049; A63B 23/16; A61H 2201/0153; A61H 2201/0161; A61H 2201/0192; A61H 2201/1207; A61H 2201/1436; A61H 2201/1659; A61H 2201/1671; A61H 2201/1685; A61H 2201/5058; A61H 2201/5061; A61H 2201/5084; A61H 2201/5097; A63B 2210/50; A63B 2220/40; A63B 2220/51; A63B 2225/09; A63B 2225/50

(57) ABSTRACT

Disclosed is a system for providing a computer-controlled hand rehabilitation and training device. The device can be used to support the rehabilitation of pinch grip and finger flexion dexterity and strength. This device provides the capability to provide assistive or resistive forces required for opening and closing the hand during the performance of pinch grasp. The rigidity along sections corresponding to the distal fingers can be modified to modify the stiffness experienced at the tips of the fingers. Palmar force resistive sensors provide the ability to measure the normal force applied at the palm. The device can be detached or attached to crank arms to provide therapeutic regimes for rehabilitation and recovery of pinch grasp and reaching. Sensors in the device can be integrated with smart games and virtual environments to simulate picking up and placing of multiple objects.

This application is a non-provisional application claiming the benefits of provisional application no. 63/734,688 filed Dec. 16, 2024, the disclosure of which is hereby incorporated by reference for all purposes.

### FIELD OF ART

The present disclosure pertains to therapeutic physical rehabilitation, and more particularly to a system, device and method for electronically mediated therapeutic exercise adapted for persons with impaired hand function i.e., the ability to sense and control movement of the hands and fingers. The device also provides (re)training of grasp for persons who have had a hand transplant. The device can be used to support the rehabilitation of pinch grip and finger flexion dexterity and strength and provides the capability to provide assistive or resistive forces required for an opening and closing the hand during the performance of pinch grasp. The device can be detached or attached to crank arms to provide therapeutic regimes for rehabilitation and recovery of pinch grasp and reaching.

### BACKGROUND

Recovery from damage to a user's wrist, finger and rehabilitation from damage to the brain as a result of a stroke can be augmented by continuous exercise and rehabilitation to improve dexterity, range of motion and strength. Post-stroke upper-limb impairments affect millions of people worldwide. Globally, over 12.2 million people experience a stroke each year [1]. Robotic rehabilitation has the potential to provide more affordable and accessible rehabilitation. Rehabilitation robots with multiple configurations can provide comprehensive upper-limb exercise. Force and position sensors can be used from the interface and can be input to a software controller, computer or game. Performance parameters can be correlated to modify the control strategy, i.e., the force feedback experienced by patient during use. Software can be used to prescribe patient-specific individual and group therapy regimes (correlating score and error, etc.) that are fun and engaging.

The present disclosure pertains to therapeutic physical rehabilitation and provides for a system, device and method for electronically mediated therapeutic exercise adapted for persons with impaired hand function i.e., the ability to sense and control movement of the hands and fingers. This system was developed for rehabilitation of the human hand after stroke, brachial plexus injury, and injuries to the hand, fingers and wrist. To regain hand function persons, work with occupational and physical therapists. Injury or damaged motor function can diminish the capability to move and perceive the hand. This can result in impairment of hand function that is essential for self-care, play, exploratory learning, and daily activities. This device provides robotic therapy to restore pinch and precision grip in the context of hand perception categorized as tactile, proprioception and Body schema. Tactile perception refers to the brain's ability to receive, interpret and understand information from the sense of touch. Proprioception refers to the brain's understanding of the position and movement of the body. Body schema is the sensorimotor representation of the body's spatial properties. Body Schema, tactile perception and proprioception are factors in motor performance and are thought to co-activate with motor cortical circuits [2]. Sensorimotor adaptation, which is motor behavior changes caused by sensory prediction error, is thought to improve with effective somatosensory communication which may be particularly useful for patients with cognitive impairments. Rehabilitation often utilizes neuroplasticity, which relies on the brain's ability to change in structure or function in response to experience.

There is a need to provide smart low-cost devices that can be used in person or remotely with guidance of a therapist or a trained caregiver. There is need for devices that can be operated in a variety of settings, including at home, in the community, or in a clinical setting. There is a need for a cost-effective hand rehabilitation apparatus capable of providing results or biofeedback to a therapist and the patient. To engage the users the apparatus there is a growing market drive for systems designed to interact with computer simulated objects and environments to mimic real world tasks or to provide gamified tasks and challenges. The present system addresses many unmet needs. This disclosed system relates generally to systems, apparatuses, and methods for simulation and training using interactive computer graphics. The interface was devised to be operated with smart virtual gaming platforms to support and assist physical therapists in rehabilitation interventions. The apparatus functions with gaming platforms as a tool which provides a haptic or vibration user input-output and kinesthetic or movement to allow users to intuitively command and seamlessly “feel” and interact with virtual and/or remote site avatar environments. The devices is comprised of a motor connected to a power transmission linkage used to rotate the fingers to reproduce, resist or assist pinch grasp.

### SUMMARY OF THE DISCLOSURE

An aspect of the disclosed system is to measure real-time push of a hand, i.e., normal palmar forces which can be tracked over time, wherein measurable strength gains can be monitored.

Another aspect of the disclosed system is to provide a mechanism which captures individual finger and thumb key pinch measurements.

An aspect of the disclosed system is to provide one or more sensors to sense the position of moving elements (linkages) to communicate a signal to the force delivery sub-assembly.

Yet another aspect of the disclosed system is to provide a rotating sleeve that allows the wrist to flex and extend when the interface is connected to a robotic arm or linkage.

Another aspect of Applicant's system is to provide a mechanism that can be used to manipulate, reach and grasp virtual objects during whole hand supination or flexion or extension when connected to a robotic arm or linkage.

Another aspect of Applicant's system is to provide an interface that can be used as a generic hand controller device for detecting movement of one or more fingers.

Yet another aspect of Applicant's system is to provide advantages over standard hand rehabilitation devices, including sensing and measuring a capacitance corresponding to the pressure or force applied by the hand or fingers of the user.

An aspect of the disclosed system is to provide a device that can be (re) configured to match hands of varied sizes.

An aspect of the disclosed system is to provide manipulation of graphical objects in computer-simulated environment to improve rehabilitation methods and increase user productivity in a variety of occupations.

Another aspect of the disclosed system allows for the interface to be connected to an algorithm or game-based rehabilitation method which runs on a computer.

Yet another aspect of the disclosed system allows for the interface to be connected to an algorithm or game-based rehabilitation method which runs on the computer on which the game is also played.

An aspect of the disclosed system allows for allowing for data to be communicated to the relevant feature of the computerized game to provide a combination of resistance or assistance to opening and closing the hand, and to provide vibratory feedback when the user reaches a predefined goal based on the position of the linkage and force input by the user.

Yet another aspect of the disclosed system is that it may be used at a clinic or at home.

Yet another aspect of the disclosed system is its suitability for any computer game preferred by the patient.

An aspect of the disclosed system is its adaptability to patient capabilities and can provide therapist and/or algorithm-based therapy sessions that are cost effective.

Another aspect of the disclosed system is that the device is intuitively operated, and suitable for multiple ages and disabilities.

Yet another aspect of the disclosed system is that it can provide upper limb rehabilitation post-stroke.

An aspect of the disclosed system is to provide a hand input-output interface device having a paddle assembly with components positionable to accommodate and obtain a grip size to suit a hand size of an operator.

An aspect of the disclosed system is to provide a hand input-output interface device having a lockable and foldable thumb contact assembly that is adjustable to allow contact with the operator's thumb.

An aspect of the disclosed system is to provide a hand input-output interface device having a grip assembly comprising a rotating transverse axis sleeve connectable to a crank of a robot arm or linkage to allow for reaching and wrist flexion and extension by the operator in conjunction with opening and closing a grasp.

An aspect of the disclosed system is to provide a hand input-output interface device having a grip assembly configured along a transverse axis of the operator's palm.

An aspect of the disclosed system is to provide a hand input-output interface device having a grip assembly with one or more force sensors and one or more vibratory motors.

An aspect of the disclosed system is to provide a hand input-output interface device having a linkage assembly to transmit torque/power to resist or assist the pinch grasp of the operator.

An aspect of the disclosed system is to provide a hand input-output interface device used to rehabilitate or train pinch grip i.e., position of the fingers and thumb via flexion/extension about the metacarpophalangeal joints of the fingers and abduction/adduction about the metacarpophalangeal joint of the thumb.

An aspect of the disclosed system is to provide a hand input-output interface device having a snap fit pinch bar that can be used to quickly connect or disconnect the linkage assembly and a main handle of the grip assembly.

An aspect of the disclosed system is to provide a hand input-output interface device having a motor and gear assembly to provide assistive or resistive forces to challenge and aid the operator in the performance of pinch grasp movements.

An aspect of the disclosed system is to provide a hand input-output interface device having a solenoid switch connected to one or more detent springs in the adjustable contact paddle to vary a stiffness of a contact paddle.

An aspect of the disclosed system is to provide a hand input-output interface device having one or more sensors and motors that can be integrated into a robotic rehabilitation platform with machine learning and artificial intelligence capabilities to make the system adaptive to the success of the operator's efforts.

An aspect of the disclosed system is to provide a hand input-output interface device having a control system to engage the operator during tailored therapeutic interventions.

An aspect of the disclosed system is to provide a hand input-output interface device connectable via wifi, Bluetooth or the like to enable exergames or rehabilitation games as a game controller.

An aspect of the disclosed system is to provide a hand input-output interface device having a crank handle to enable a quick interchangeability with various end-effectors, or handles.

An aspect of the disclosed system is to provide a hand input-output interface device having a reconfigurable mount to allow a robot to be positioned vertically or horizontally in order to target specific physical movements associated with reaching and grasping objects.

An aspect of the disclosed system is to provide a hand input-output interface device having one or more of an accelerometer, a gyrometer, an orientation sensor.

An aspect of the disclosed system is to provide a hand input-output interface device having a wireless transmitter and a printed circuit board that receives information from the force sensors and transmits data from using the wireless transmitter to a processor including computer code configured to receive information from one or more load sensors and the one or more force sensors to determine a change in load force and a grip force exerted through the linkage.

An aspect of the disclosed system is to provide a hand input-output interface device having a and covering into which the operator may insert a hand to facilitate useability and dexterity.

These and other advantages of the disclosed device will appear from the following description and/or appended claims, reference being made to any accompanying drawings that form a part of this specification. It is to be understood that the disclosed method and apparatus are not limited in application to the details of the particular arrangements shown; the disclosed method and apparatus each capable of other embodiments. Also, the terminology used herein is for the purpose of description and not of limitation.

### BRIEF DESCRIPTION OF THE DRAWINGS

FIGS. 1A, 1B, and 2 illustrate the hand training apparatus configured to measure the grip strength and pinch strength exerted by a hand.

FIGS. 3A, 3B and 3C depict the solenoid detent mechanism of the hand training apparatus.

FIGS. 3D and 3E illustrate the actuator of the solenoid detent in an open configuration.

FIGS. 4A and 4B depict a user activating the hand training apparatus.

FIGS. 5A and 5B illustrate the adjustability of the thumb paddle and the rotating contoured grip.

FIGS. 6A-6B illustrate various views of the hand training apparatus.

FIG. 6C depicts the linkage with finger contacts and the gear that connects to the coupling gearbox.

FIGS. 7A-7C depict coupling mechanisms of the hand training apparatus.

FIGS. 8A-8H and FIGS. 10A-10E illustrate the components of the hand training apparatus in various configurations.

FIGS. 9A-9F and 11A-11C illustrate various positions of a user's hand during use of the hand training apparatus in various configurations.

FIGS. 12A, 12B illustrate various configurations of the linkage mechanism of the hand training apparatus.

### DESCRIPTION

The following description is provided to enable any person skilled in the art to make and use the disclosed system and method. Various modifications, however, will remain readily apparent to those skilled in the art, since the generic principles of the present apparatus have been defined herein specifically to provide for a system, device and method for an electronically mediated therapeutic exercise adapted for persons with impaired hand function i.e. the ability to sense and control movement of the hands and fingers.

The present device measures real-time push of a hand, i.e., normal palmar forces which can be tracked over time. With this feature, measurable strength gains can be monitored. Furthermore, the disclosed device captures individual finger and thumb key pinch measurements. Sensors sense the position of a moving element (linkage) which is communicated by a signal to the force delivery sub-assembly. A rotating sleeve allows the wrist to flex and extend when the interface is connected to a robotic arm or linkage. When connected to a robotic arm or linkage, the device can be used to manipulate, reach and grasp virtual objects during supination or flexion or extension. The interface can be used as a generic hand controller device for detecting movement of one or more fingers. The device was developed to provide advantages over standard hand rehabilitation devices, including sensing and measuring a capacitance corresponding to the pressure or force applied by the hand or fingers of the user. The device can be (re) configured to match hands of varied sizes. Manipulation of graphical objects in a computer-simulated environment holds increasing promise for improving rehabilitation methods and increasing the productivity of users in a variety of occupations. The interface can be connected to an algorithm or game-based rehabilitation method which runs on a computer, on which the game is also played. When the user reaches a predefined goal based on the position of the linkage and force input by the user which then is communicated to the relevant feature of the computerized game to provide a combination of resistance or assistance to opening and closing the hand, and to provide vibratory feedback. The method is useable at a clinic or at home and is suitable for any computer game preferred by the patient. The device is adaptable to patient capabilities and can provide therapist and/or algorithm-based therapy sessions that are cost effective. The device is intuitively operated, and suitable for multiple ages and disabilities [3]. Low-cost rehabilitation robots may provide more accessible upper limb rehabilitation post-stroke [4]. Recent studies have shown that with smart reconfiguring, a 1-Degree of Freedom robot is capable of inducing different muscle activation patterns, suggesting that such robots are a promising platform for low-cost rehabilitation exercise and characterizing pathological synergistic movements [5].

According to an embodiment of the disclosed system, a therapeutic interface for the hand is provided. The interface is comprised of motor enclosed within the base of the interface which is proximal to the small or pinky finger. The main body of the interface is comprised of a housing and at least one motor coupled with a geared subassembly proximal to the thumb connected to scissor type linkages that move the thumb and fingers in opening and closing to perform pinch grasp and release. At least one electronic switch having an on and off mode that is connected to a spring detent which applies preset high and low resistance to fingertip forces applied by the user. The spring detent is connected to the adjustable finger contact paddle. Coupled to the finger contact linkage via a geared assembly is a foldable thumb paddle which can be positioned to contact or connect with the thumb. The apparatus integrates at least one capacitive sensor disposed on a surface of the palmar section of the device; at least one processor disposed in the housing; and at least one memory including computer program code for one or more programs disposed in the housing, with the at least one processor, cause the apparatus to apply an information to the motor and finger contact switch. For various example embodiments, the following is applicable: a method comprising the means for determining the palmar force applied and the motor input to the linkages corresponding to finger forces and position. Data measures of the hardware and user inputs can be integrated into robotic rehabilitation which utilizes machine learning and artificial intelligence capabilities to make the system adaptive to the success of the subject's efforts.

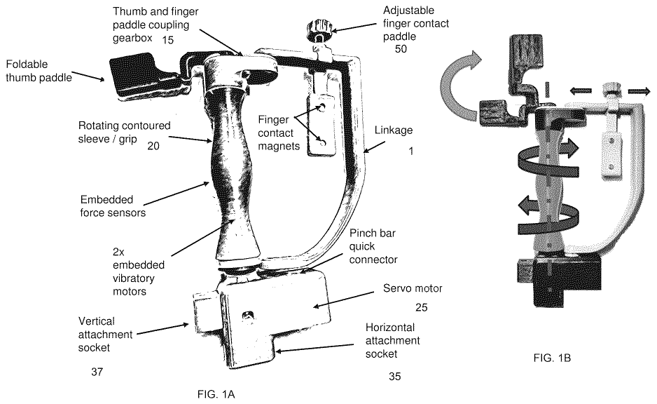

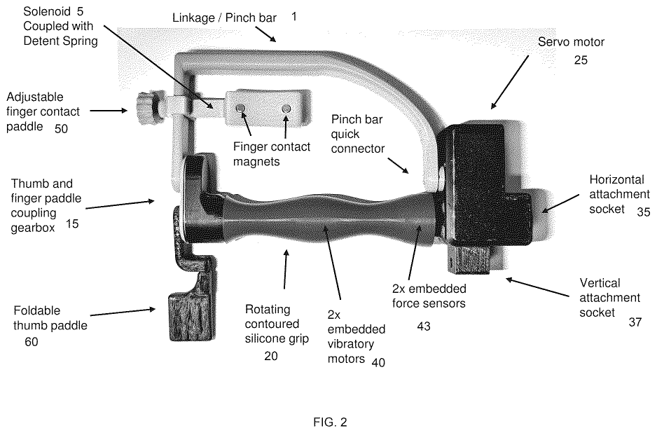

One embodiment of the device comprises multiple modular, sub-assemblies such as an ergonomically designed palmar axial grip 20 as shown in FIG. 1A and FIG. 2. The palmar grip 20 can rotate about the long axis of the palm, in counterclockwise or clockwise directions as illustrated in FIG. 1B. The contoured grip 20 can be ergonomically contoured and incorporates a movement interpretation circuit, a touch detection circuit and/or one or more force transducers. The grip 20 is enclosed by a rotating sleeve that can rotate along the long axis of the grip and allows for flexion and extension of the wrist when operating the device. It rests along the transverse axis of the palm with a plurality of force sensors and vibratory motors.

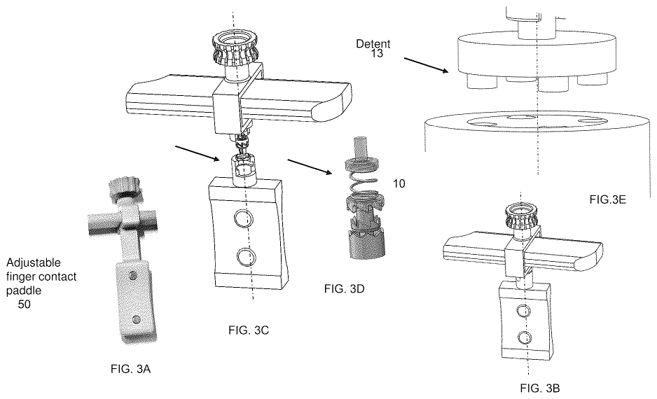

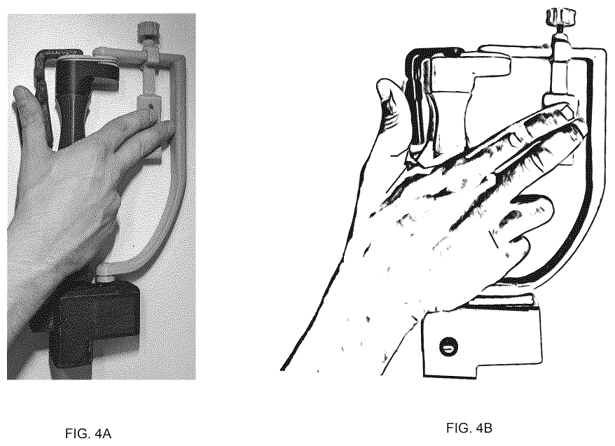

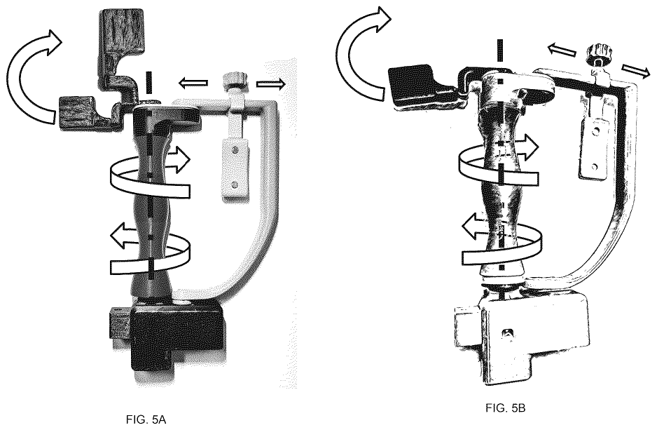

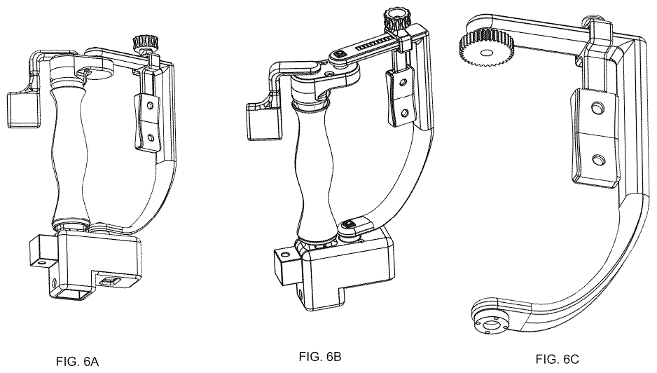

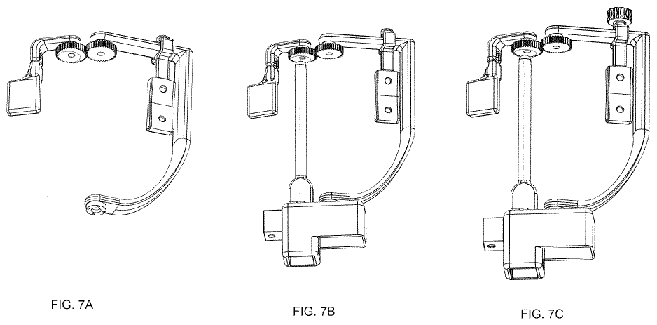

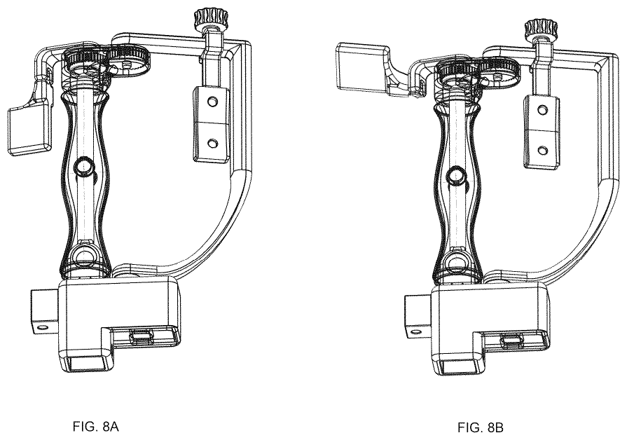

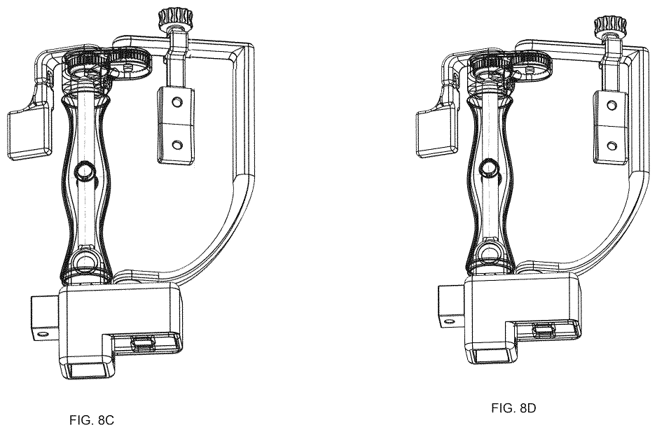

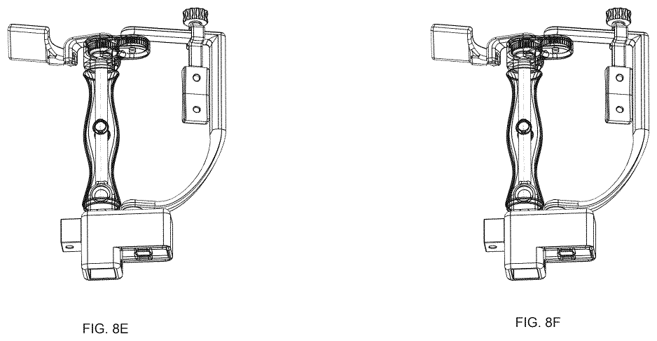

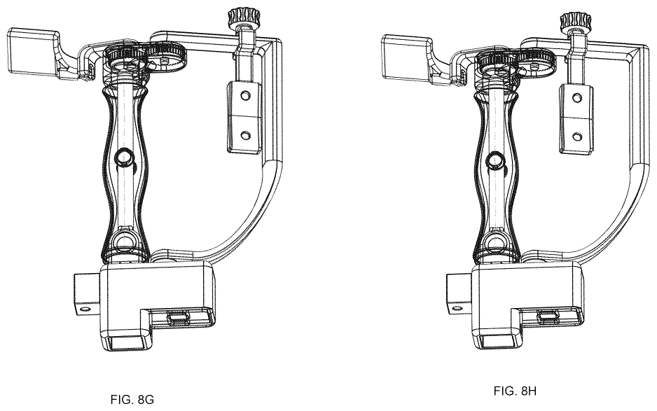

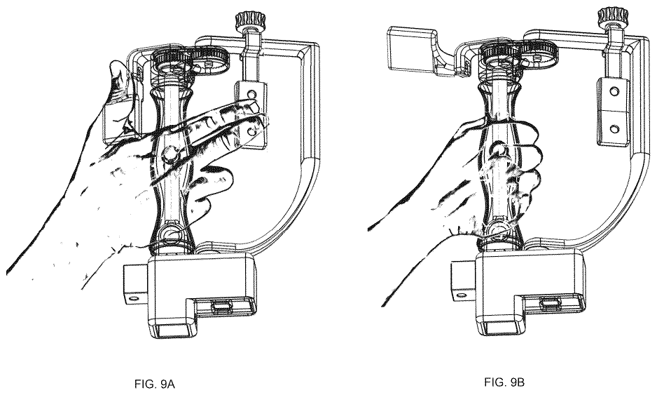

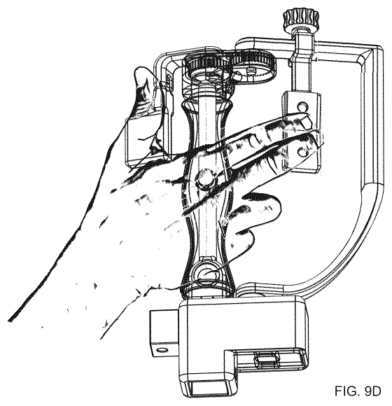

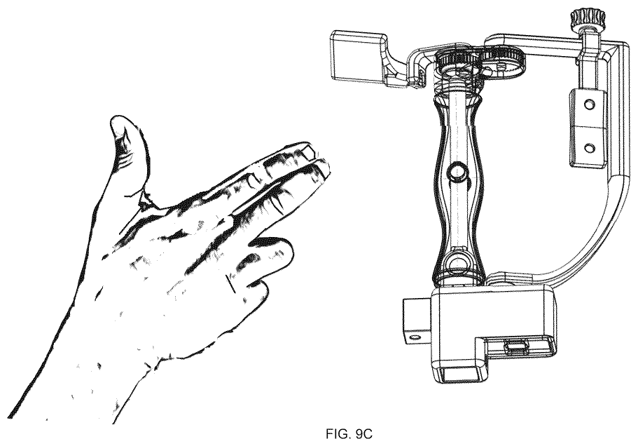

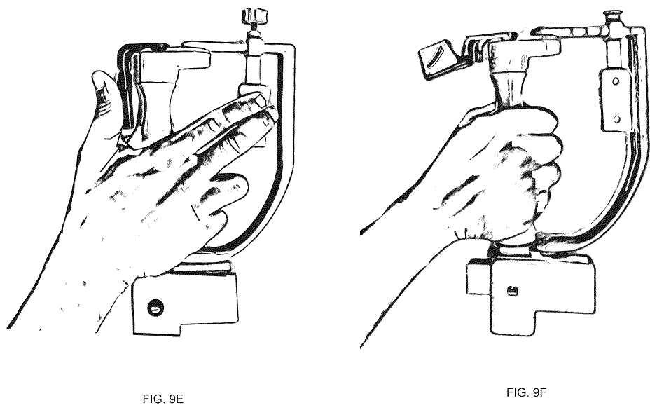

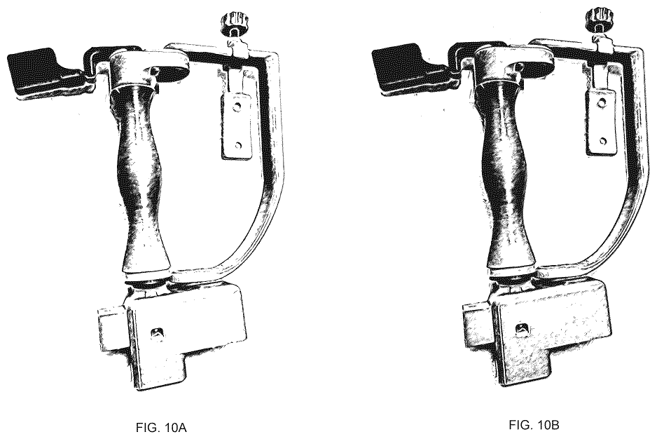

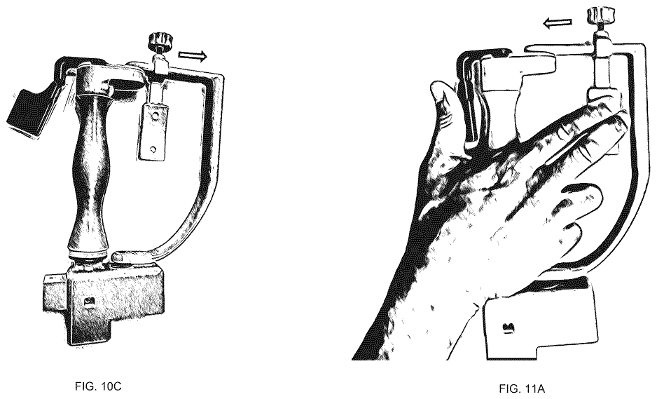

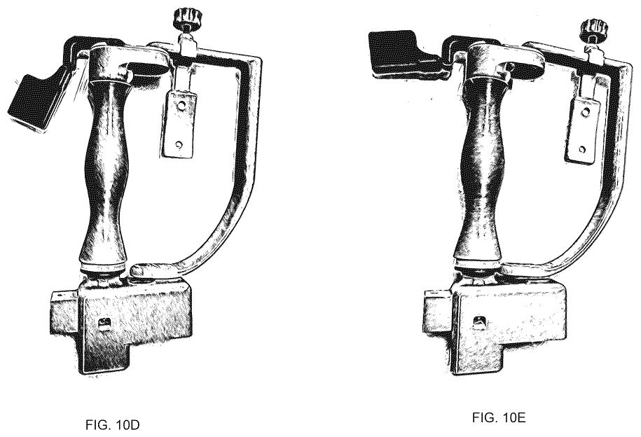

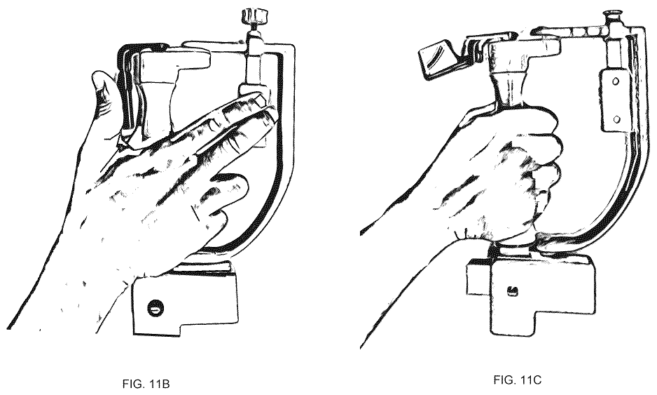

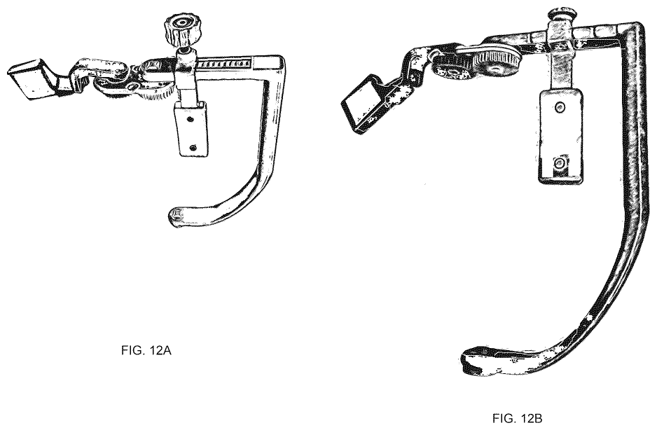

Linkage/pinch bar 1 is connected to an adjustable finger contact paddle assembly 50 comprising solenoid switch 5 connected to with detent spring 10 (see FIG. 3D). Linkage 1 is connected to gearbox 15 of rotating grip 20. Linkage 1 is connected to servo motor 25 by means of a quick connector 30. Grip 20 comprises a horizontal attachment socket 35 and a vertical attachment socket 37. Grip 20 further comprises embedded vibratory motors 40 and embedded force sensors 43. Spring 10 is compressible in the same fashion as a writing pen spring. Detents 13 may be affect rotatability and may be rigid or non-rigid.

A one-degree of freedom (1-DOF) robotic thumb and finger contact assembly 15 having a placement on the device can be adjusted to optimize manipulability for different user hand sizes. Adjustable finger index and middle finger contact paddle/lever 50 can be adjusted to accommodate fingers of varying lengths and be positioned out of reach from contact with the user's index and middle fingers. In addition, the device may comprise a foldable thumb contact 60. The locking foldable thumb contact paddle/lever 60 can be adjusted to allow contact with a user's thumb. Linkage 1 when connected to the placement device 20 transmits forces that correspond to forces generated by the user and/or forces generated by a computer-controlled motor or similar device. Compact gearbox 15 coupled to linkage 1 is capable of transferring forces to and from the foldable thumb contact 60.

In one embodiment, the disclosed device may incorporate a glove or hand covering into which an operator may insert a hand to provide for increased usability and limited dexterity.

The disclosed hand input-output interface comprises a paddle having components that can be positioned to accommodate and to obtain a grip size which suits the hand size of the person using the interface. An adjustable finger index and middle finger contact paddle/lever can be adjusted to accommodate fingers of varying lengths and be positioned out of reach from contact with the user's index and middle fingers. The disclosed device comprises a locking foldable thumb contact paddle/lever that can be adjusted to allow contact with a user's thumb. A rotating transverse axis sleeve and corresponding assembly is connectable to a crank of a conventional robotic arm or linkage. The device allows reaching and wrist flexion and extension in conjunction with an open and closing grasp. The device further comprises an ergonomically designed grip which rests along the transverse axis of the palm with a plurality of force sensors and vibratory motors. Linkage 1 transmits torque/power to resist or assist the pinch grasp. Vertical attachment socket 37 can be quickly connected or disconnected from a robotic arm or a platform. Horizontal attachment socket 35 can be quickly connected or disconnected from a robotic arm or a platform. A snap fit/pinch bar can be used to quickly dis/connect linkage 1 from the main handle. The disclosed device utilizes the force sensors resistors on opposite sides of the housing and determines a change in load force and a grip force exerted through the linkages. The disclosed system may integrate an accelerometer, a gyrometer, an orientation sensor (or both), a wireless transmitter, a printed circuit board that receives information from the sensors and transmits data from using the wireless transmitter to a processor including computer code configured to receive information from the one or more load sensors and the two or more grip force sensors. The disclosed system comprises a solenoid switch 5 connected to a detent spring 10 in the adjustable finger contact 50. The device can be connected via wifi and may be compatible with Bluetooth or other capable connections to be used with exergames or rehabilitation games as a game controller.

It is contemplated that this apparatus can be used to rehabilitate or train pinch grip i.e., position of the fingers and thumb via flexion/extension about the metacarpophalangeal joints of the fingers and abduction/adduction about the metacarpophalangeal joint of the thumb. The motor and gear assembly can be used to provide assistive or resistive forces challenge or aid the user in the performance of pinch grasp movements. Further, the interface can be connected to a crank handle-hub which allows for quick interchangeability of various end-effectors, or “handles.” A reconfigurable mount allows the robot to be positioned vertically or horizontally in order to target specific physical movements associated with reaching and grasping objects. Sensors and motors integrated within the interface can be integrated into a robotic rehabilitation platform which utilizes machine learning and artificial intelligence capabilities to make the system adaptive to the success of the subject's efforts. The system can be implemented via computer controls, via human control or via a gaming platform to engage the user during tailored therapeutic interventions. The spring detents connected to the finger contact can be used to vary stiffness of the contact. This can be used to engage distal flexors in the fingers of the hand.

Although the disclosed device and method have been described with reference to disclosed embodiments, numerous modifications and variations can be made and still the result will come within the scope of the disclosure. No limitation with respect to the specific embodiments disclosed herein is intended or should be inferred.

### References

[1] World Stroke Organization, “WSO Global Stroke Fact Sheet,” 2022. Accessed: 2024-10-28.
[2] Seim C E, Ritter B, Starner T E, Flavin K, Lansberg M G, Okamura A M. Design of a Wearable Vibrotactile Stimulation Device for Individuals With Upper-Limb Hemiparesis and Spasticity. IEEE Trans Neural Syst Rehabil Eng. 2022; 30:1277-1287. doi: 10.1109/TNSRE.2022.3174808. Epub 2022 May 17. PMID: 35552152; PMCID: PMC10139869.
[3] K. A. Leech, R. T. Roemmich, J. Gordon, D. S. Reisman, and K. M. Cherry-Allen, “Updates in motor learning: Implications for physical therapist practice and education,” Physical therapy, vol. 102, no. 1, p. 1, 2022.
[4] E. L. Waters, R. J. Mendonca, P. Z. Cacchione and M. J. Johnson, “TheraDyad: Feasibility of an Affordable Robot for Multi-User Stroke Rehabilitation,” 2024 10th IEEE RAS/EMBS International Conference for Biomedical Robotics and Biomechatronics (BioRob), Heidelberg, Germany, 2024, pp. 1498-1503
[5] N. Y. Meng et al., “Analysis of Induced Muscle Activations by an Affordable, Reconfigurable Robot for Comprehensive Post-Stroke Rehabilitation,” 2025 International Conference On Rehabilitation Robotics (ICORR), Chicago, IL, USA, 2025, pp. 1361-1367, doi: 10.1109/ICORR66766.2025.11063060.

We claim:

1. A hand input-output interface device comprising:
a paddle assembly having components positionable to accommodate and obtain a grip size to suit a hand size of an operator;
the paddle assembly comprising an adjustable contact paddle to accommodate fingers of varying index finger and middle finger lengths, the paddle assembly being positionable so as to avoid with the operator's index or middle fingers;
a lockable and foldable thumb contact assembly that is adjustable to allow contact with the operator's thumb;
a grip assembly comprising a rotating transverse axis sleeve connectable to a crank of a robot arm or linkage to allow for reaching and wrist flexion and extension by the operator in conjunction with opening and closing a grasp, wherein the grip assembly rests along a transverse axis of the operator's palm, the grip assembly further comprising one or more force sensors and one or more vibratory motors;
a linkage assembly to transmit torque/power to resist or assist the pinch grasp of the operator;
a vertical attachment socket that can be quickly connected or disconnected from a robotic arm or a platform;
a horizontal attachment socket that can be quickly connected or disconnected from a robotic arm or a platform; and
wherein the device can be used to rehabilitate or train pinch grip i.e., position of the fingers and thumb via flexion/extension about the metacarpophalangeal joints of the fingers and abduction/adduction about the metacarpophalangeal joint of the thumb.

2. The device of claim 1 further comprising a snap fit pinch bar that can be used to quickly connect or disconnect the linkage assembly and a main handle of the grip assembly.

3. The device of claim 1 further comprising a motor and gear assembly to provide assistive or resistive forces to challenge and aid the operator in the performance of pinch grasp movements.

4. The device of claim 1, wherein the paddle assembly further comprises a solenoid switch connected to one or more detent springs in the adjustable contact paddle to vary a stiffness of the contact paddle.

5. The device of claim 1 further comprising one or more sensors and motors that can be integrated into a robotic rehabilitation platform having machine learning and artificial intelligence capabilities to make the system adaptive to the success of the operator's efforts.

6. The device of claim 5 further comprising a control system to engage the operator during tailored therapeutic interventions.

7. The device of claim 6, wherein the control system comprises computer controls, human controls or a gaming platform.

8. The device of claim 1 further comprising a connection via wifi, Bluetooth or the like to enable exergames or rehabilitation games as a game controller.

9. The device of claim 1 further comprising a crank handle to enable a quick interchangeability with various end-effectors, or handles.

10. The device of claim 1 further comprising a reconfigurable mount to allow a robot to be positioned vertically or horizontally in order to target specific physical movements associated with reaching and grasping objects.

11. The device of claim 1 further comprising one or more of an accelerometer, a gyrometer, an orientation sensor.

12. The device of claim 1 further comprising a wireless transmitter and a printed circuit board that receives information from the force sensors and transmits data from using the wireless transmitter to a processor including computer code configured to receive information from one or more load sensors and the one or more force sensors to determine a change in load force and a grip force exerted through the linkage.

13. The device of claim 1 further comprising a hand covering into which the operator may insert a hand to facilitate useability and dexterity.
